(19) United States
(12) Patent Application Publication
(10) Pub. No.: US 2020/0091733 A1
(43) Pub. Date: Mar. 19, 2020

(54) OFF-GRID REGENERATIVE POWER SYSTEM

(71) Applicant: William Peterson, New Cumberland, PA (US)

(72) Inventor: William Peterson, New Cumberland, PA (US)

(21) Appl. No.: 16/135,918

(22) Filed: Sep. 19, 2018

(51) Int. Cl. H02J 7/00; F03B 13/10; F03D 9/25; H02J 3/46; H02S 40/38

(52) U.S. Cl. CPC H02J 7/0021; F03B 13/10; H02S 40/38; H02J 3/46; H02J 7/0055; F03D 9/25

(57) ABSTRACT

An off-grid electrical system has at least one power source selected from the group consisting of photovoltaic cells, wind turbines, or fluid turbines. At least one generator electrically connected to the at least one power source, wherein the at least one power source converts one or more environmental factors into energy processed by the at least one generator. A plurality of battery banks, wherein at least one battery bank is storing energy from the at least one generator, while a second battery bank is discharging energy. A micro controller controlling the charging and discharging of the plurality of battery banks, wherein the micro controller simultaneously transfers operations of the plurality of battery banks between charging and discharging.

### CROSS-REFERENCE TO RELATED APPLICATION(S)

Not applicable

### BACKGROUND OF THE INVENTION

### 1. Field of Invention

The present invention relates to the field of electrical power systems. More particularly to battery reserved alternating power infrastructural systems.

### 2. Description of Related Art

Demand for electrical power has fueled innovation to push the levels of efficiency and lower the reliance on traditional power grids. Generator based systems have been used to provide a conversion of mechanical to electrical energy in a number of circumstances.

As the demand for energy increases, focus on efficient utilization of renewable energy sources becomes more important. Generally referred to a green energy systems or off-grid systems, solar, wind, hydroelectric, and other sources of energy are derived from natural phenomenon to be used in personal or commercial applications. For example, a mechanical or photovoltaic power source receives energy from an environmental source, such as wind or the sun, and that energy is then transferred to a motor in a generator set. The electricity is then, generally utilized. Some green energy systems require mechanical components necessary to convert the source energy to useable electricity. For example, generators may employ clutch mechanism to control operation of the generator. The clutch systems are inefficient and essentially draw power out of the system thereby slowing the conversion of energy into an acceptable form for use.

The lack of efficient conversion and storage of green energy are stifling the development and expansion of its use. This requires the continued reliance on other traditional forms of fuel driven energy which are harmful to the planet and are subject to depletion.

Based on the foregoing, there is a need in the art for an off-grid electrical system using environmental energy sources providing energy to be stored in one or more battery banks for subsequent storage and use. A system whereby when one of the battery banks is allowing for discharge of the stored electric load, a separate battery bank is continuing storage of energy received from the electrical sources through a generator set. A microcontroller is necessary to efficiently control the flow of electricity into and out of the battery banks.

### SUMMARY OF THE INVENTION

An off-grid electrical system has at least one power source selected from the group consisting of photovoltaic cells, wind turbines, or fluid turbines. At least one generator electrically connected to the at least one power source, wherein the at least one power source converts one or more environmental factors into energy processed by the at least one generator. A plurality of battery banks, wherein at least one battery bank is storing energy from the at least one generator, while a second battery bank is discharging energy. A micro controller controlling the charging and discharging of the plurality of battery banks, wherein the micro controller simultaneously transfers operations of the plurality of battery banks between charging and discharging.

In an embodiment, the discharged energy is electrical, and wherein the electrical energy is configured to power one or more external devices.

In an embodiment, the system is scalable, wherein a larger system comprises at least two generators, and more than two battery banks.

In an embodiment, the plurality of battery banks each comprise multiple 12 volt deep cell batteries.

In an embodiment, the at least one generator is rated between 25,000 to 50,000 watts.

In an embodiment, the system further comprising at least one alternator and at least one inverter.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a schematic view of the off-grid regenerative energy system, according to an embodiment of the present invention;

FIG. 2 is a schematic view of the off-grid regenerative energy system, according to an embodiment of the present invention;

FIG. 3 is a schematic view of the off-grid regenerative energy system, according to an embodiment of the present invention; and

FIG. 4 is a schematic view of the off-grid regenerative energy system, according to an embodiment of the present invention.

### DETAILED DESCRIPTION OF PREFERRED EMBODIMENTS

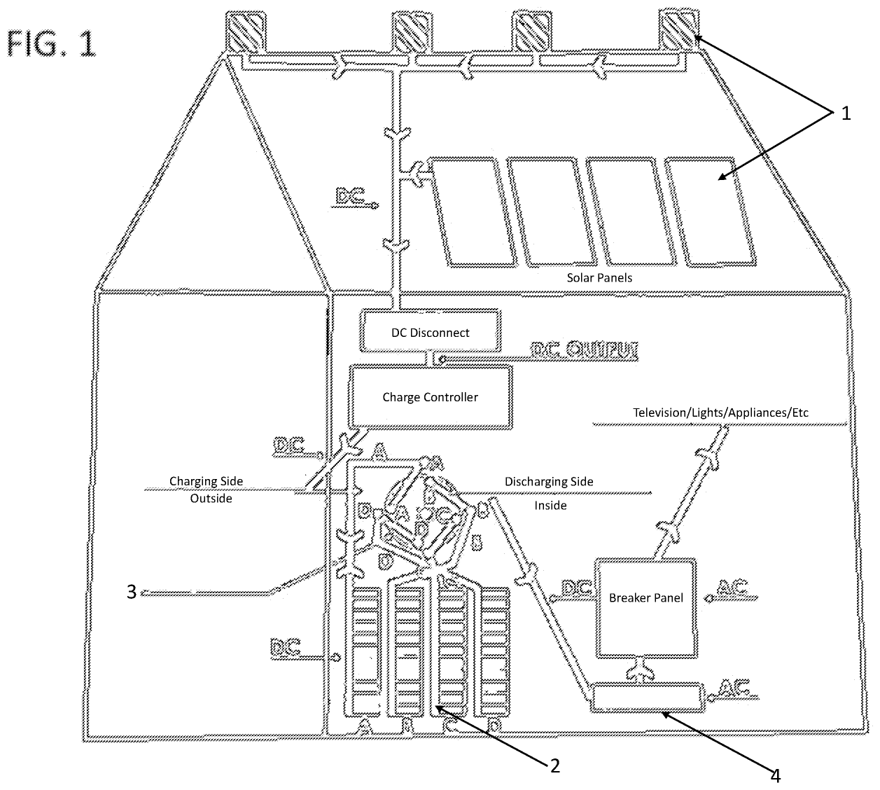

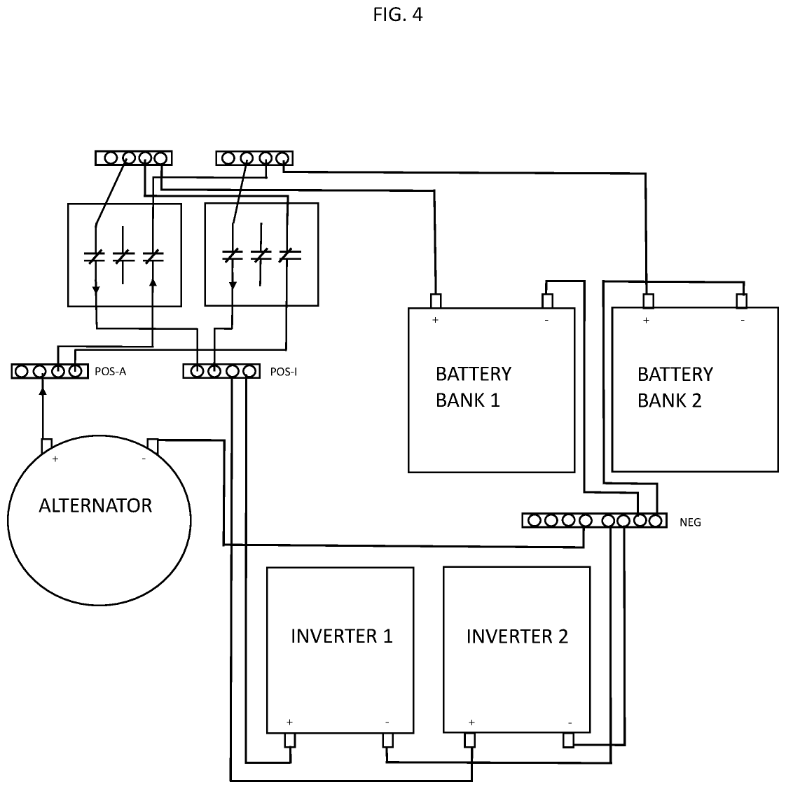

Preferred embodiments of the present invention and their advantages may be understood by referring to FIGS. 1-4, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

The present invention will now be described in detail with reference to embodiments thereof as illustrated in the accompanying drawings.

An off-grid regenerative power system has at least a bank of deep cycle batteries electrically connected to at least one generator. A microcontroller operates synchronization of the transfer of electrical energy between the generator and the deep cycle batteries. The batteries are arranged in at least one bank for storage and subsequent transmission of stored electrical energy received from the generator set. One or more energy sources are in communication with the at least one generator to drive the electric motor therein. The power sources may be one or more photovoltaic cells, wind turbines, or other fluid driven turbines (not shown). As the power source engages environmental factors driving the power source, the energy received is converted into mechanical or electrical energy and transferred through the present system driving the generator to charge the batteries.

As illustrated in FIG. 1, an off-grid regenerative energy system (‘system’) has one or more input power sources 1. Theses input sources may be green energy sources derived from naturally occurring events such as solar, wind, water flow, geothermal, etc. The input power source is generally disposed in a position resulting in optimal capture of the naturally occurring event. For example, an input source utilizing solar energy may be positioned on top of a building or structure to maximize exposure to the radiant energy of the sun. The input power sources are electrically connected to the system. The input power sources transfer electrical energy converted from their respective source into the system for processing and transfer throughout the system. The system has one or more batteries 2 for storage of surplus energy obtained. The transfer of electrical energy passes through one or more converters, one or more inverters 4, and one or more switches 3. Each of the one or more switches are triggered or activated/inactivated based on one or more triggering factors. The triggering factors may be predetermined and input into the system.

In some embodiments, the triggering factors may be adapted by the system based on optimal transfer, intake, and usage of the electrical energy therein. For example, an initial triggering factor calibration may be input such that the time of day, length of sun exposure, threshold wind speeds, temperatures, barometric pressure, etc are input to provide a calibration for the system operations. The system may operate under the input conditions for a predetermined time or a dynamic time until the system identifies changes in the actual input compared to the initial input of the triggering factors. Based on the actual input of energy from the one or more power sources, the system may amend or adapt the parameters of the calibration to maximize input. The switch then controls the function of input between the input power sources.

In some embodiments, the system is in communication with a plurality of sensors positioned such that each sensor receives data regarding the actual conditions relating to the input energy source. For example, an anemometer may be positioned outside of a structure to measure wind speed. Other sensors may be positioned to measure temperature, barometric pressure, sun light exposure, etc. These sensors are in communication with the system, wherein the system processes the information received from the one or more sensors to evaluate the actual input of energy and the switch will adjust operations of the system according to the changes in the information received from the one or more sensors. In a particular example, the initial calibration may include a set number of hours of predicted sunlight, and an average wind speed. The sensors may then identify a set amount of actual sunlight that is different from the initial input. This information may provide instructions or motivation for the switch to trigger the wind turbine as an input power source at a different time based on the lack of sun light exposure.

In some embodiments, the input energy source is wind turbine. The wind turbine is configured to convert changes in air pressure and wind into mechanical energy through a wind-driven turbine. The turbine then converts the mechanism energy to electrical energy through one or more generators.

In some embodiments the input energy source is solar. One or more photovoltaic cells are positioned to receive the radiation and energy from the sun. This energy elevates the energy potential of compound within the photovoltaic cell which then transfer the change in energy into electrical energy.

In some embodiments, the input energy source is water. Flowing water sufficient to transfer enough force to a hydroelectric turbine can generate electricity through the mechanical displacement of the hydroelectric turbine.

In some embodiments, the input energy is geothermal energy. In such an embodiment, geothermal conversion elements are disposed within the surface of the earth. The thermal energy created by the pressure under the surface creates heat which can be converted by the geothermal conversion elements into electricity.

In some embodiments, an alternator is provided in communication with the system that provides rotation of conductive metals within a magnetic field. Such action operates to direct a flow of electrical energy, which is converted from the rotational/mechanical energy. The alternator is in electrical communication with the batteries, such that the alternator charges the batteries.

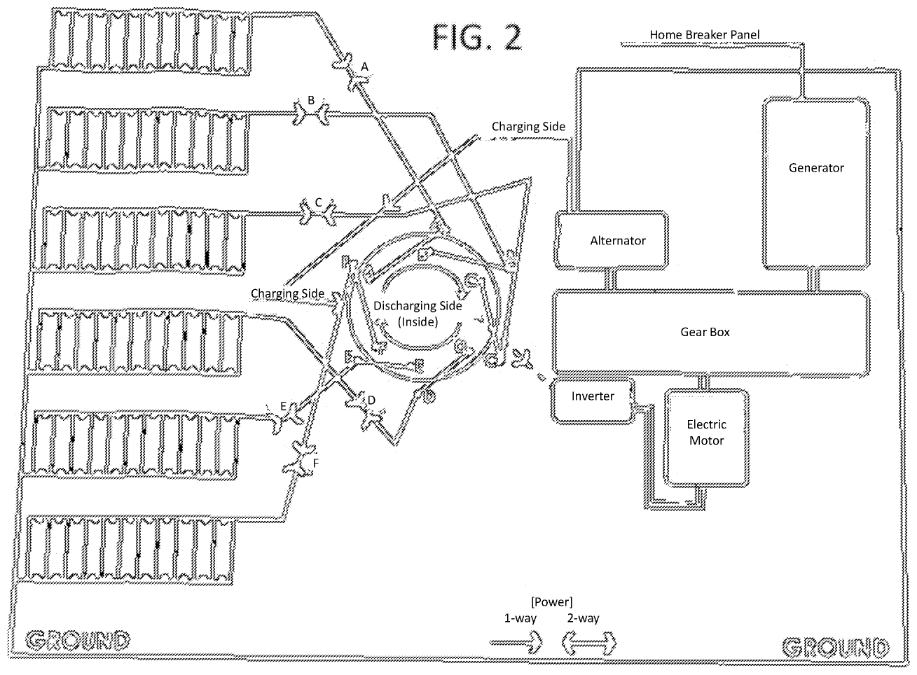

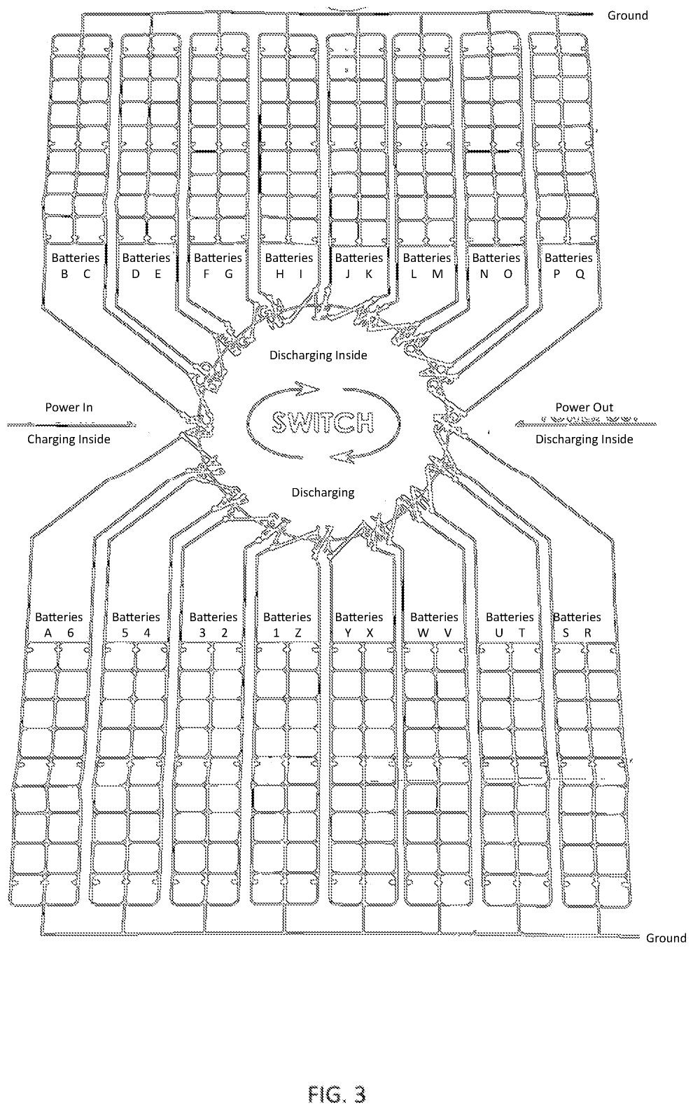

In some embodiments, the switch is provided in electrical communication with the system between the one or more energy sources and the bank. FIGS. 2 and 3 illustrate embodiments whereby the switch operates in conjunction with the micro controller to provide for selective control of the flow of energy into and out of the system. The switch is used to select for the appropriate phase of the energy flow within the system. For example, the switch operates to control and regulate charging during times of surplus energy generated by the energy source. Then, when one or more of the energy sources produces less energy, the switch will operate to improve efficiency and prevent waste to the low energy source. A specific example involves a wind turbine and solar panel. During the day with wind, the system is switched to allow for energy input from both sources. During the night, with wind, the solar panel input is switched off to allow for focus on the energy generated by the wind turbine without allowing for energy loss to operation of the solar panel.

In an embodiment, threshold values are predetermined and input into the micro controller for the switch operation. The threshold values instruct the selective operation of the switch based on energy input and output values from each of the energy sources.

In another embodiment, the battery discharge is metered and controlled by the system for gradual and on-demand flow of the electrical energy. The micro controller functions to control and prevent surges or spikes in energy discharge prolonging the life and supply of the batteries within the bank.

In some embodiments, a power inverter is provided to regulate electricity within the system between the generator and the batteries for storage. The generator set has at least an electric motor and a gear box for optimized operation of the motor.

In an embodiment, there are at least two battery banks, each having multiple deep cycle batteries. The micro controller operates synchronization of the charging and release mechanisms whereby the battery banks are split between a charging bank and a used bank. The micro controller operates as a switch alternating between usage of the battery banks based on their charge and capability for use. For example, as one bank is charging, the microcontroller diverts stored energy to the system from the other bank. The batteries are configured to retain electrical energy produced by the one or more input power sources until there is a need for discharge of the stored energy. The need for a discharge is generally based on use or requirements for consumption of electricity within a structure, vehicle, or other substrate to which the system is connected to.

In some embodiments, one or more breaker panels may be electrically connected to the system to regulate potential fluctuations within the system. The breaker panel may have one or more fuses set for a particular voltage and amperage.

In some embodiments, one or more capacitors may be electrically connected to the battery banks and the microcontroller to allow for further regulation of the discharging of a stored electrical load.

In an alternative embodiment, multiple generators are provided in communication with the power sources, as seen in FIG. 2. The multiple generators are controlled by one or more automated switches controlling their conversion of energy for storage within the battery banks. Multiple battery banks are provided to optimize the system based on the required need. For example, the system may be scaled up or down depending on the structure(s) being connected to the system. The system may be scaled to provide power for an entire community through a plurality of generator sets connected to multiple power sources and multiple battery banks. One or more microcontrollers regulate the storage and allowed usage of stored electricity within the system.

In an alternative embodiment, multiple different power sources are used. For example solar, wind, and water energy conversion means are connected to one or more of the generators within the system. With the various power sources, transfer of energy into the system is optimized as one system may provide for more energy at different times of the day or year.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. An off-grid electrical system comprising:
a. at least one power source selected from the group consisting of photovoltaic cells, wind turbines, or fluid turbines;
b. at least one generator electrically connected to the at least one power source, wherein the at least one power source converts one or more environmental factors into energy processed by the at least one generator;
c. a plurality of battery banks, wherein at least one battery bank is storing energy from the at least one generator, while a second battery bank is discharging energy;
d. a micro controller controlling the charging and discharging of the plurality of battery banks, wherein the micro controller simultaneously transfers operations of the plurality of battery banks between charging and discharging.

2. The system of claim 1, wherein the discharged energy is electrical, and wherein the electrical energy is configured to power one or more external devices.

3. The system of claim 1, wherein the system is scalable, wherein a larger system comprises at least two generators, and more than two battery banks.

4. The system of claim 1, wherein the plurality of battery banks each comprise multiple 12 volt deep cell batteries.

5. The system of claim 1, wherein the at least one generator is rated between 25,000 to 50,000 watts.

6. The system of claim 5, further comprising at least one alternator and at least one inverter.
